(19) United States
(12) Patent Application Publication
(10) Pub. No.: US 2007/0291329 A1
(43) Pub. Date: Dec. 20, 2007

(54) Optical Transparent Media Adapter

(76) Inventor: Kurt Eugene Spears, La Jolla, CA (US)

Correspondence Address: HDSL, 4331 STEVENS BATTLE LANE, FAIRFAX, VA, 22033, US

(21) Appl. No.: 11/424,231

(22) Filed: Jun. 14, 2006

(51) Int. Cl. H04N 1/04

(52) U.S. Cl. 358/506; 358/487

(57) ABSTRACT

A thin transparent media adapter is used when scanning transparent media on a contact image sensor or reduction optics scanner. The adapter uses illumination from an existing scanner light source to illuminate a diffuser and the media. A lens assembly is used to focus the light from the media to create an intermediate image between the adapter and the scanner platen glass. The adapter is an optical assembly that forms an intermediate image of the transparent media in the image side focal plane of existing scanner optics. The existing scanner optics can then capture and focus the light from the intermediate image onto the scanner's existing sensor array. The adapter magnetically couples to the scan system to allow the lens array to follow movement of the optical system of the scanner.

### BACKGROUND OF THE INVENTION

1. Field of the Invention

The present invention relates to an optical scanning system. More specifically, the present invention discloses an optical adapter that magnetically couples with a contact image sensor scanner module, which uses the illumination from the scanner for effectively scanning transparent media and uses an optical element to create an intermediate image in the focal plane of the scanner module.

2. Description of the Prior Art

A conventional image scanner is capable of producing digital images from printed text or photographic images. In the tradition system, an opaque media is place on the platen glass of the scanner. A light source in the scanner emits light onto the opaque media in order to illuminate the media. Light is reflected off the media and is picked up by a series of lenses or a lens array. The lens array focuses the reflected light onto a sensor array which captures the light in order to produce the digital image of the opaque media. However, while the conventional image scanner is useful when used with opaque media, it is ineffective when used with transparent media.

Opaque media is capable of reflecting light whereas the light emitted from the scanner light source will simply pass through the transparent media. As a result, the sensor array is unable to detect a useful amount of light and cannot capture an accurate image of the transparent media. Therefore until now, it was necessary to utilize a dedicated secondary illumination system for transparent media.

A dedicated transparent media illumination system houses the light source in a cover over the top of the transparent media and emits the light on the back of the media. The lens array mounted in the bottom of the scanner then focuses the light onto the sensor array. The sensor array captures the light in order to capture a digital image of the transparent media. Either a large light emitting panel or a moving light source is required for the illumination system. However, these illumination system solutions are relatively expensive since a light source and optionally an additional motor and drive system are required in the cover.

Additionally, alignment and coordination between the bottom system and cover system is complex and prone to misalignment.

Furthermore, it is a waste of resources to require the need for a dedicated illumination system when a conventional image scanner can be adapted to scan transparent media.

Furthermore, contact image sensor modules have a small depth of focus that prevents accurate scanning of transparent media that is not located in the optimal focal plane.

Therefore there is need for an optical transparent media adapter that efficiently flattens and backlights transparent media and which can be used with a contact image scanner module.

### SUMMARY OF THE INVENTION

To achieve these and other advantages and in order to overcome the disadvantages of the conventional method in accordance with the purpose of the invention as embodied and broadly described herein, the present invention provides a media adapter with magnetically coupled optics for scanning transparent media.

The transparent media adapter (TMA) can be utilized for scanning transparent media on a contact image sensor (CIS) scanner. The present invention provides an optical assembly that uses illumination from an existing scanner and forms an intermediate image of the transparent media in the focal plane of the existing scanner optics. The existing scanner optics can then capture and focus the light from the intermediate image onto the scanner's existing linear sensor array.

The transparent media adapter of the present invention comprises a lens array, a plurality of prisms, an optional image side optical component, a diffuser, and a media holder. The transparent media adapter uses illumination from the existing scanner to illuminate the diffuser and media. A prism reflects the light from the media towards a lens array. After passing through the lens array, the light is reflected by a second prism towards an image side optical component. The image side optical component is used to create an optical path difference which will shift the focus location of the light to create an intermediate image between the transparent media adapter and the scanner platen glass at the optimal focus plane of the underlying scan module.

A magnet attached to the transparent media adapter magnetically couples with the optical system of a scanner. As the optical system moves, the transparent media adapter follows the movement. This allows the transparent media adapter to follow the movement of the scanner as it scans and allows the transparent media adapter and the underlying scan module to properly align and move in a synchronized manner.

An advantage of the present invention is that a contact image sensor scanner can be used to scan transparent media without the need for a specialized secondary illumination system and can be used to scan media that would normally be outside of the scanner's limited depth of focus.

Additionally, since the TMA does not comprise any active electronic components, no power supply, motor, or drive system are required. As a result, the cost and complexity of the device are significantly reduced.

The present invention has the advantage of providing a compact, low cost transparent media adapter that can be magnetically coupled to the scan system. This allows the cost of the transport system to be reduced because the need for a motor and drive belt are eliminated. The TMA captures a large amount of light which can be transmitted to the underlying scanner module. Additionally, the TMA has the advantage that it can transfer the media image to the correct focal plane for the underlying scan module. This is particularly important for CIS based scanners because they have very shallow depth of field and cannot scan media that is above the platen glass.

As a result, the present invention solves the problem of how to flatten and backlight transparent media in a scanner and how to locate the media in the focal plane of the module, which is typically located very close to the top surface of the platen glass. Additionally, the present invention reduces the cost and complexity of the TMA solution.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a drawing illustrating a side view of an optical system of an image scanner and transparent media adapter according to an embodiment of the present invention;

FIG. 1a is a drawing illustrating a side view of an optical system of an image scanner and transparent media adapter according to an alternative embodiment of the present invention;

FIG. 2 is a drawing illustrating a side view of an optical system of an image scanner and compact magnetically coupled transparent media adapter according to an embodiment of the present invention; and

FIG. 3 is a drawing illustrating a top view of a compact transparent media adapter with transparent media according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

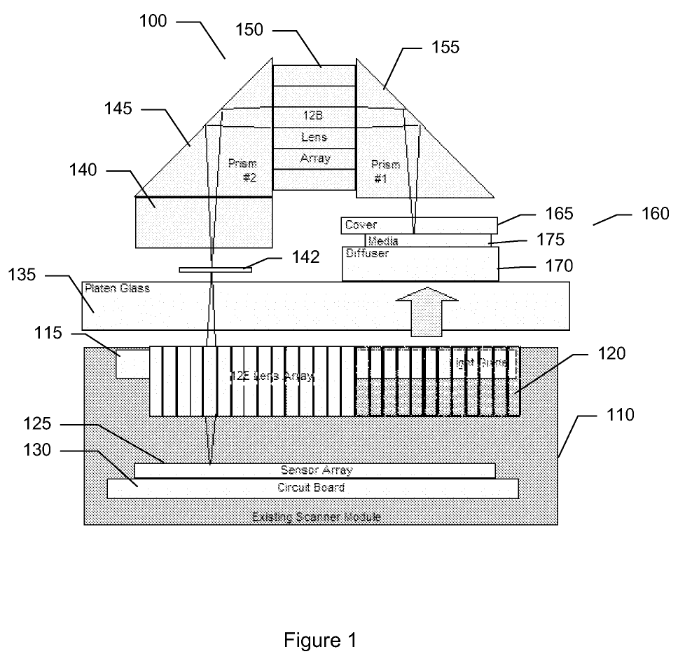

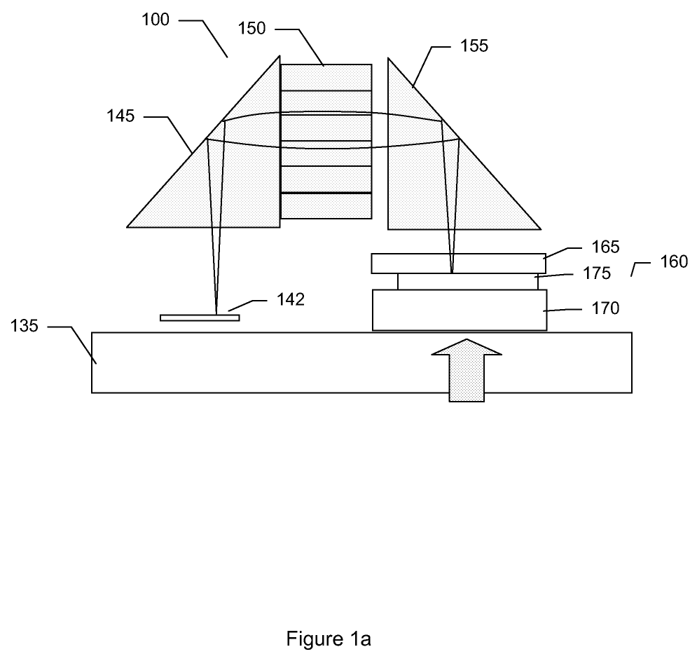

Refer to FIG. 1, which is a drawing illustrating a side view of an optical system of an image scanner and transparent media adapter according to an embodiment of the present invention and to FIG. 1a, which is a drawing illustrating a side view of an optical system of an image scanner and transparent media adapter according to an alternative embodiment of the present invention. As shown in FIG. 1, a scanner module 110 comprises a circuit board 130 with a sensor array 125, a light source 115, and a lens array 120. The scanner module 110 is located below platen glass top 135. In conventional image scanning, for example scanning a page of printed text, the light source 115 emits light to illuminate the printed text. The lens array 120 focuses the light reflected from the page onto the sensor array 125. The sensor array 125 and circuit board 130 capture the digital image of the printed text. However, in order to capture a digital image of transparent media 175, for example a 35 mm slide, the media 175 must be backlit or illuminated from behind the media 175.

In the embodiment shown in FIG. 1, the transparent media adapter of the present invention comprises a media holder 160, a diffuser 170, and a lens assembly 100. The lens assembly comprises a first prism 155, a TMA lens array 150, a second prism 145, and an image side optical component 140. The media holder 160 flattens and positions the transparent media 175. The diffuser 170 diffuses light emitted by the light source 115 of the scanner module 110 and illuminates the media. The first prism 155 reflects the light from the illuminated transparent media 175 towards a TMA lens array 150. A second prism 145 reflects the light from the lens array 150 towards an image side optical component 140. The image side optical component 140 is used to shift the focus of the light to create a intermediate image 142 between the transparent media adapter and the scanner platen glass 135 at a location where it can be effectively captured by the lens array 120 of scan module 110.

In other embodiments alternatives to the image side optic 140 are used to shift the focus location of intermediate image 142. In FIG. 1a an air gap is introduced between the first prism 155 and the lens array 150 while the second prism 145 remains adjacent to the lens array 150. Because the lens array 150 has unity magnification and identical focal distances on both the object and image sides, the presence of the air gap on the object side will shift the location of intermediate image 142 on the image side by a distance equal to the size of the air gap. In alternative embodiments of the present invention other methods are used to shift the focal plane of the intermediate image 142.

In this way, the transparent media adapter of the present invention efficiently creates an intermediate image 142 of the transparent media 175 so that the scanner module 110 can capture a digital image of the media 175.

In some embodiments each prism is basically a coated right angle prism that allows light to enter from below (where the diffuser 170 is located) and allows light to exit into the lens array 150 located on the left. Therefore, the first prism 155 has transparent surfaces on the bottom and left side and the 45 degree surface of the first prism 155 is a mirror that reflects light or an internally reflecting surface with an air gap behind the prism.

The second prism 145 is similar to the first prism 155. It has transparent surfaces on the right face and bottom face and is mirrored on the 45 degree surface.

In an embodiment of the present invention, the media holder 160 comprises a media holder base and diffuser 170 and a media holder cover 165. The media holder cover 165 located above the transparent media 175 is transparent.

In the embodiment illustrated in FIG. 1, the TMA is magnetically coupled to scan module 110 during the scanning operation, the TMA moves in synchronization with the scanner light source 115 and lens array 120 across the transparent media 175.

In FIG. 1, the scanner module 110 uses a lens array 120 such as 12E lens array available from Nippon Sheet Glass to focus the intermediate image 142 onto the sensor array 120 to enable the scanner module 110 to capture an image of the media 175.

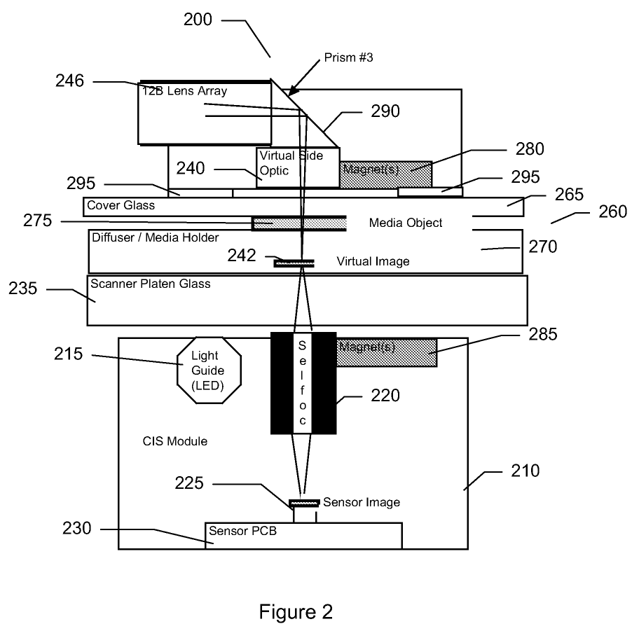

Refer to FIG. 2, which is a drawing illustrating a side view of an optical system of an image scanner and compact magnetically coupled transparent media adapter according to an embodiment of the present invention.

In the embodiment illustrated in FIG. 2, a third prism 290 is added to allow the first prism 255, the second prism 245, and the lens array 250 to be located in a horizontal orientation. This allows the transparent media adapter to achieve a very low profile. Since the orientation of the lens array and first and second prisms cannot be accurately illustrated, these elements are denoted as 246 in FIG. 2.

Additionally, magnets 280, 285 that are used to couple the existing scan module and the TMA have been added. This allows the TMA and the underlying scan module to properly align and move in a synchronized manner. The magnets 280, 285 keep the TMA aligned with the scan module as it moves from left to right or from right to left. As a result, multiple slides or negatives can be scanned in a single scanning operation.

Since the magnets 280, 285 magnetically couple with each other, the motor and drive system of the existing scan module effectively moves the lens assembly 200 of the transparent media adapter. Therefore, there is no need for a separate motor or drive system for the TMA. This greatly reduces the cost and complexity of the TMA.

As shown in FIG. 2, light emitted from the scanner light source 215 is diffused by the diffuser 270 and illuminates the media 275. This illumination is reflected by the third prism 290 and directed to the first prism 246. The first prism 246 reflects this light and directs it to the second prism 246 via the lens array 246. The second prism reflects the light toward the third prism 290. Finally, the third prism 290 reflects the light to the image side optical component 240 that shifts the focus location of intermediate image 242 of the transparent media. The scanner lens array 220 focuses this light onto the scanner sensor 225 which captures the image.

In this embodiment, the first prism, the second prism, and the lens array are positioned in a horizontal orientation so the overall height of the TMA is reduced making the TMA more compact.

A TMA magnet 280 or a plurality of TMA magnets are attached to the transparent media adapter 200. A scanner magnet 285 or a plurality of scanner magnets is attached to the scan module 210. The TMA magnet 280 couples with the scanner magnet 285. As the scan module 210 moves across the transparent media 275 the magnetically coupled transparent media adapter 200 moves in a synchronized manner in the same direction and creates an intermediate image of the transparent media 275 using light from the scan module 210. This allows images of larger or multiple transparent media objects to be captured.

A plurality of sliders 295 is positioned on the bottom of the TMA 200 to enhance movement of the TMA 200. These sliders cooperate with the physical properties of the media holder cover 265 to provide a low friction environment in which the TMA moves across the media holder cover 265. In some embodiments multiple sliders are used. In other embodiments a single slider is used. In yet other embodiments, the bottom of the TMA is treated, coated, or fabricated from low-friction material to act as a slide.

In the embodiment illustrated in FIG. 2, two magnets, one on the TMA module and one on the scan module are shown. However in other embodiments, more than two magnets are used to provide accurate side to side alignment. For example, multiple magnets located in several locations across the scan line provide more accurate alignment than magnets at a single location. Additionally, in some embodiments one or both of the magnets are replaced by an electromagnet to provide magnetic coupling whenever electrical current is flowing in the electromagnet electrical coils.

In another embodiment of the present invention, the TMA module or scan module use a metal plate instead of a magnet, as long as the magnet on the other module is strong enough to provide sufficient coupling to the metal plate. For example, when using a scan module with a metal plate instead of a magnet installed, positioning a magnet or magnets on the TMA module allows the magnet of the TMA module to couple with the metal plate on the scan module and follow the scan module movement. Alternatively, a metal plate is attached to the TMA. A magnet on the scan module couples to the metal plate and allows the TMA to move with the scan module.

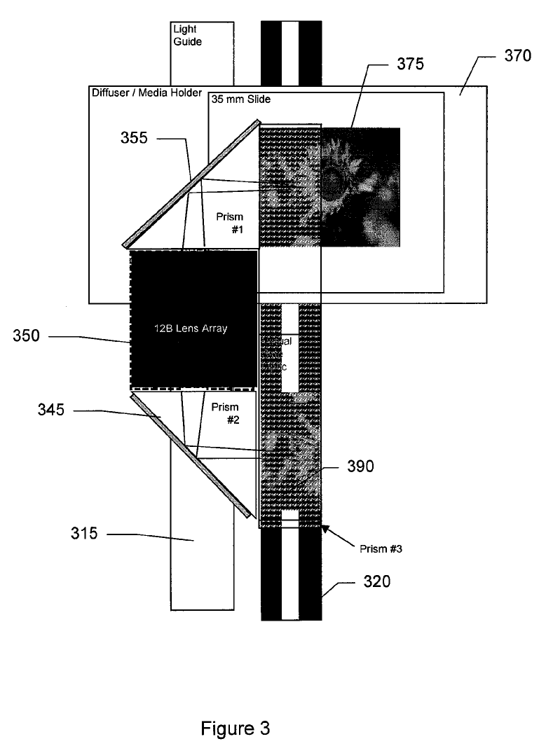

Refer to FIG. 3, which is a drawing illustrating a top view of a compact transparent media adapter with transparent media according to an embodiment of the present invention.

In FIG. 3, a top view of the TMA is shown with a 35 mm slide as an example. Obviously, the transparent media 375 can be a negative, film, transparency, or other type of transparent media.

This view illustrates the direction of light through the TMA. In use, the transparent media 375 is installed in the media holder 370. Once the scan operation begins, light is emitted from the light source 315 of the scan module. This light is diffused by the diffuser and illuminates the transparent media. The light shines onto the third prism 390 and is reflected to the first prism 355. This light is then reflected into the lens array 350 and travels to the second prism 345. The second prism 345 reflects the light onto the third prism 390 that reflects the light to the image side optical component. The image side optical component creates an optical path difference that shifts the focus location of intermediate image between the transparent media adapter and the scanner platen glass. The lens array 320 of the scan module cooperates with the sensor of the scan module to capture an image of the transparent media. As a result, light from a light source of a scan module is used to effectively and efficiently illuminate the transparent media and the optical components in the TMA create an intermediate image that can be captured by lens array 320 of the scan module.

The light rays forming the intermediate image created by the TMA can be captured by the underlying scan module as long as the capture angle of the underlying scanner is larger than the light angels that form the intermediate image. For the 12E lens array, the capture angle is approximately 6 degrees in the y direction and 12 degrees in the x direction (along the scan line). For a TMA using the 12B lens array from Nippon Sheet Glass, the light angles at the intermediate image allow the image to be completely captured provided the 12E and 12B are aligned to +/−0.5 mm. Beyond this range, the percentage of light captured decreases as the misalignment increases. This means it is important to achieve good alignment and good magnetic tracking to capture all the light present in the intermediate image.

In the above embodiments, the TMA comprises two or three prisms; first prism and second prism or first prism, second prism, and third prism. In the embodiment illustrated in FIG. 2 and FIG. 3, the third prism is one piece that extends from the first prism to the second prism. However, in other embodiments of the present invention the TMA comprises other configurations. For example, in other embodiments, the third prism comprises two separate pieces. One piece positioned with the first prism and another piece with the second prism. In another embodiment the third prism is formed together with the first prism and the second prism. In another embodiment the first prism, second prism, and third prism are formed in one piece.

In an embodiment of the present invention, the TMA is manufactured by creating an outer molded assembly and aluminizing the inner surfaces. For example, using the prisms as a mold insert, the housing is molded around the prisms. When the mold insert is removed, all the inner surfaces of the part are aluminized to be reflective. As a result, a mirrored cavity in the shape of the prisms is achieved. Alternatively, the TMA is built with glass or plastic. In other embodiments the prisms are mirrors, mirrored surfaces, or other types of reflective surfaces.

Furthermore, in some embodiments of the present invention, the TMA comprises optical fibers to transfer light from illuminated media to the image side optic module. This allows the passive transparent media adapter to achieve an extremely low profile. For example, a plurality of optical fibers is installed in a housing. Light from the illuminated media travels through the optical fibers and is emitted at the intermediate image focal plane.

As described above, the present invention provides a compact, low cost transparent media adapter that is magnetically coupled to the scan system. This allows the cost of the transport system to be reduced because the need for a motor and drive system are eliminated.

The present invention utilizes light from the system's existing scan module to backlight transparent media and focuses this light to create an intermediate image of the transparent media so it can be imaged by the underlying scanner module. The TMA transfers the media image to the correct focal plane for the underlying scan module. This is particularly important for CIS based scanners because they have very shallow depth of field and cannot scan media that is above the platen glass.

Additionally, the TMA is passive meaning it has no active electronic components. As a result, it is simpler to integrate into existing scan systems because it utilizes the existing illumination and sensor systems and their corresponding control systems. Since the TMA has no active electronics or illumination, it does not require control or power to operate. The magnetic coupling allows the optical components to be optimized to efficiently illuminate and image a narrow section of the media that moves in sync with the scan module. This allows multiple frames of negative and slides to be captured in a minimal amount of time.

The passive transparent media adapter of the present invention solves the problem of how to flatten and scan transparent media for a CIS or reduced optics based scanner. Because it is passive, it reduces the cost and complexity of the TMA solution.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An optical transparent media adapter for a scanner module, comprising:
a media holder for holding transparent media;
a lens assembly for focusing light from the transparent media to create an intermediate image of the transparent media; and
at least one adapter coupling means connected to the transparent media adapter for magnetically coupling to an optical system of the scanner module.

2. The optical transparent media adapter of claim 1, the adapter coupling means comprising at least one magnet or electromagnet.

3. The optical transparent media adapter of claim 1, further comprising:
a diffuser for diffusing light from a light source onto the transparent media.

4. The optical transparent media adapter of claim 1, the lens assembly further comprising a lens array.

5. The optical transparent media adapter of claim 1, the lens assembly comprising:
a lens array; and
a plurality of reflective surfaces for reflecting light from the transparent media through the lens array to create the intermediate image of the transparent media.

6. The optical transparent media adapter of claim 1, the lens assembly comprising:
a first prism for reflecting light from the transparent media;
a second prism for reflecting light from the first mirror; and
a lens array between the first prism and the second prism

7. The optical transparent media adapter of claim 1, further comprising:
an optic module for changing focus location of the intermediate image of the transparent media.

8. The optical transparent media adapter of claim 1, the lens assembly comprising:
a third prism for reflecting light from the transparent media;
a first prism for reflecting light from the third prism;
a second prism for reflecting light from the first mirror;
a lens array between the first prism and the second prism; and
a fourth prism for reflecting light from the second prism to the optic module.

9. The optical transparent media adapter of claim 8, further comprising:
an optic module for changing focus location of the intermediate image of the transparent media.

10. The optical transparent media adapter of claim 1, the lens assembly further comprising a plurality of slides for facilitating movement of the lens assembly.

11. An optical transparent media adapter for a scanner module comprising:
a media holder for holding transparent media;
a diffuser between a light source and the transparent media for diffusing light emitted by the light source;
a lens assembly for focusing light from the transparent media to create an intermediate image of the transparent media; and
at least one lens assembly coupling means for magnetically coupling the lens assembly to an optical system of the scanner module.

12. The optical transparent media adapter of claim 11, the lens assembly coupling means comprising at least one magnet or electromagnet.

13. The optical transparent media adapter of claim 11, the lens assembly further comprising a lens array.

14. The optical transparent media adapter of claim 11, the lens assembly comprising:
a lens array; and
a plurality of reflective surfaces for reflecting light from the transparent media to create the intermediate image of the transparent media.

15. The optical transparent media adapter of claim 11, the lens assembly comprising:
a first prism for reflecting light from the transparent media;
a second prism for reflecting light from the first mirror; and
a lens array between the first prism and the second prism.

16. The optical transparent media adapter of claim 15, further comprising:
an optic module for changing focus location of the intermediate image of the transparent media.

17. The optical transparent media adapter of claim 11, the lens assembly comprising:
a third prism for reflecting light from the transparent media;
a first prism for reflecting light from the third prism;
a second prism for reflecting light from the first mirror;
a lens array between the first prism and the second prism; and
a fourth prism for reflecting light from the second prism to the optic module.

18. The optical transparent media adapter of claim 17, further comprising:
an optic module for changing focus location of the intermediate image of the transparent media.

19. The optical transparent media adapter of claim 11, the lens assembly further comprising a plurality of slides for facilitating movement of the lens assembly.

20. An optical transparent media adapter for a scanner module comprising:
a media holder for holding transparent media;
a diffuser between a light source of the scanner module and the transparent media for diffusing light emitted by the light source;
a lens assembly for focusing light from the transparent media to create an intermediate image of the transparent media, the lens assembly comprising:
a lens array; and
a plurality of reflective surfaces for reflecting light; and
at least one lens assembly coupling means for magnetically coupling the lens assembly to an optical system of the scanner module.

21. The optical transparent media adapter of claim 20, the lens assembly coupling means comprising at least one magnet or electromagnet.

22. The optical transparent media adapter of claim 20, the plurality of reflective surfaces comprising:
a first prism for reflecting light from the transparent media;
a second prism for reflecting light from the first mirror;
where the lens array is positioned between the first prism and the second prism.

23. The optical transparent media adapter of claim 22, the lens assembly further comprising:
an optic module for changing focus location of the intermediate image of the transparent media.

24. The optical transparent media adapter of claim 20, the plurality of reflective surfaces comprising:
a third prism for reflecting light from the transparent media;
a first prism for reflecting light from the third prism;
a second prism for reflecting light from the first mirror;
a lens array between the first prism and the second prism; and
a fourth prism for reflecting light from the second prism to the optic module.

25. The optical transparent media adapter of claim 24, further comprising:
an optic module for changing focus location of the intermediate image of the transparent media.

26. The optical transparent media adapter of claim 20, the lens assembly further comprising a plurality of slides for facilitating movement of the lens assembly.
